(19) United States
(12) Patent Application Publication
(10) Pub. No.: US 2013/0339941 A1
(43) Pub. Date: Dec. 19, 2013

(54) METHODS OF DISTRIBUTING SOFTWARE

(71) Applicant: Daniel Shelton, Berkshire (GB)

(72) Inventor: Daniel Shelton, Berkshire (GB)

(73) Assignee: Antix Labs Ltd., Berkshire (GB)

(21) Appl. No.: 13/994,269

(22) PCT Filed: Dec. 16, 2011
(86) PCT No.: PCT/EP2011/073088

§ 371 Date: Sep. 9, 2013

(30) Foreign Application Priority Data
Dec. 23, 2010 (GB) 1021875.8

(51) Int. Cl. G06F 9/445

(52) U.S. Cl. CPC G06F 8/65
USPC 717/172

(57) ABSTRACT

The invention relates to a system for transferring from one end-user device to another an entire binary-portable computer software application, including any libraries required by the application and saved application state. The binary-portable nature of the computer software application allows this to happen across dissimilar types of devices, including different CPU types and operating-systems. This enables use-cases which are not typically possible using traditional systems, such as taking an in-progress saved game on one device, transferring the game, libraries and game state to a second device and then continuing to play the game from the same point on the second device, all without any requirement to have a connection to a server to download the necessary libraries or an installation package for the application. This allows off-network distribution of applications and their state, reducing costs for the end-user, reducing network load, and speeding up the transfer of the application.

### 1. FIELD OF THE INVENTION

The present invention relates to a method of distributing software, and to computer readable media carrying such software. It relates in particular, although not exclusively, to software such as computer games which are designed to be exchanged between users of portable devices such as mobile phones.

### 2. INTRODUCTION

Many general-purpose computer systems allow a user to copy application state data manually—for example word-processor documents, etc. It is also quite common for games consoles to allow the user to copy saved game state onto external media (for example the WII and GameCube consoles allow this).

Some gaming platforms allow a user to transfer certain game state information such as recordings of a car race to other players, such that the receiving player can effectively race against a recorded game and is challenged to try to beat a particular score or time. High-scores are another example of game-state items which are commonly shared among a community of players.

The J2ME Java application environment for mobile devices in some cases has the facility to send applications directly from one user to another.

According to the present application there is provided a method of distributing binary-portable software comprising:
(a) running a software application on a first user device and storing application state data defining a state of the software application;
(b) receiving from a second user device details of required software components needed to run the software application and not already installed, or details of required software components needing updating;
(c) generating a package for transfer to the second user device including the application state data and the required software components;
(d) transferring the package to the second user device;
(e) determining whether the said state has already been saved at the second user device; and
(f) providing an option to a user of the second user device to run the software application from the said state.

The invention further extends to a computer-readable media storing program code for implementing on a digital computer (such as a mobile phone) the method of claim 1.

The invention may be carried into practice in a number of ways and several specific embodiments will now be described by way of example, with reference to the accompanying figures, as follows:

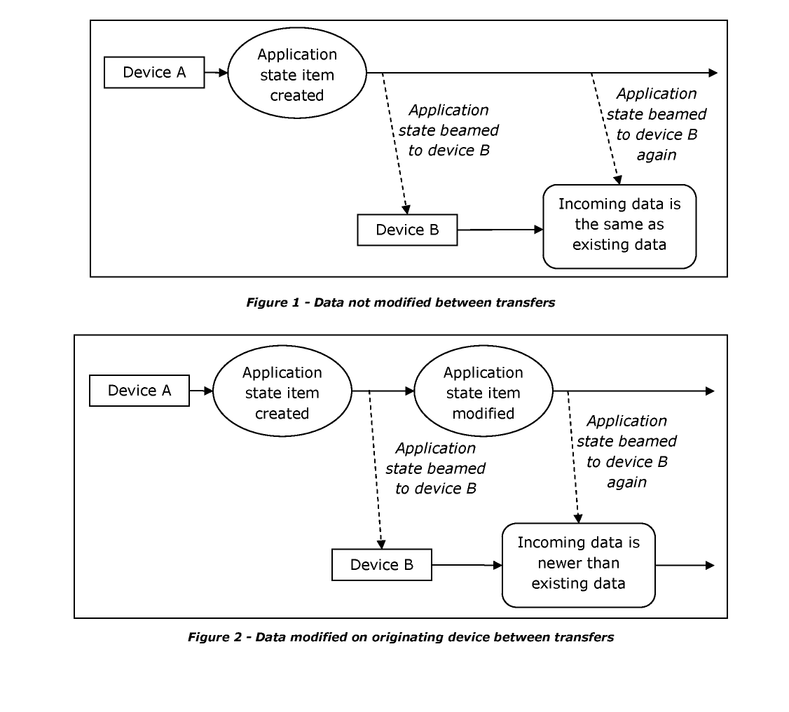

FIG. 1—Data not modified between transfers.

FIG. 2—Data modified on originating device between transfers.

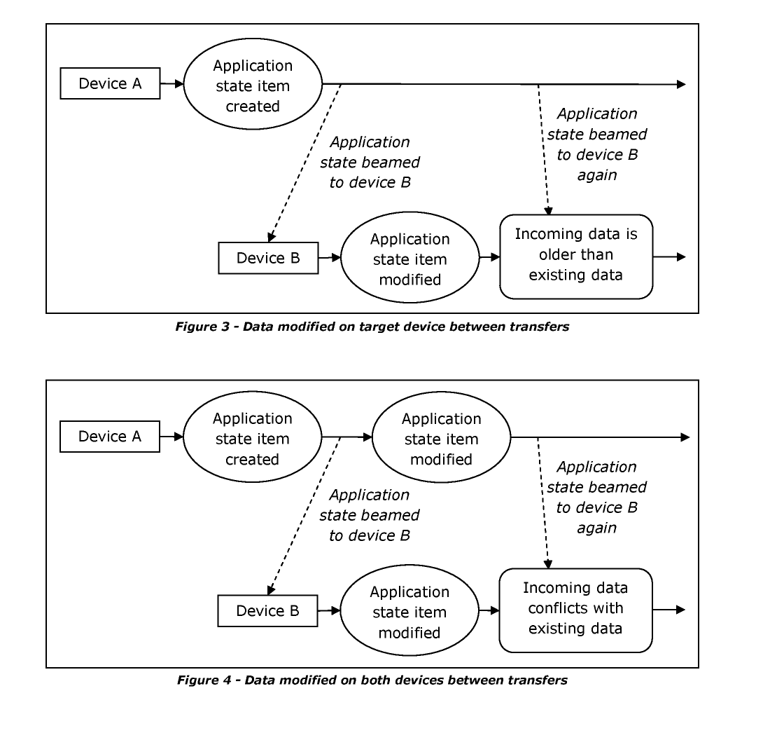

FIG. 3—Data modified on target device between transfers.

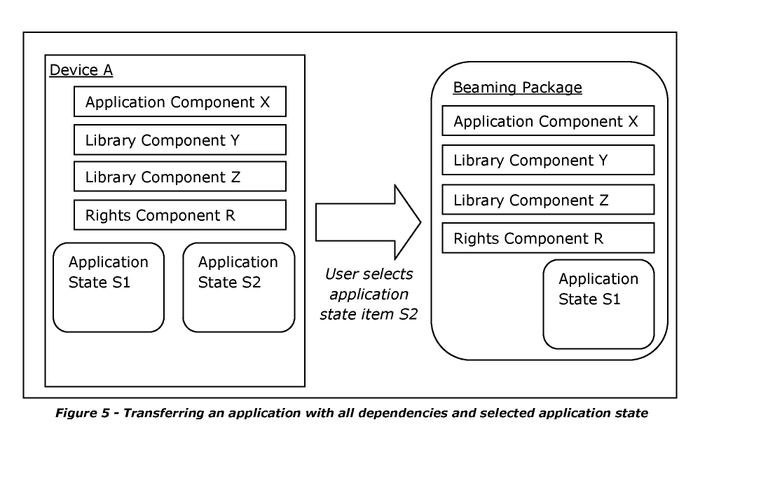

FIG. 4—Data modified on both devices between transfers.

FIG. 5—Transferring an application with all dependencies and selected application state.

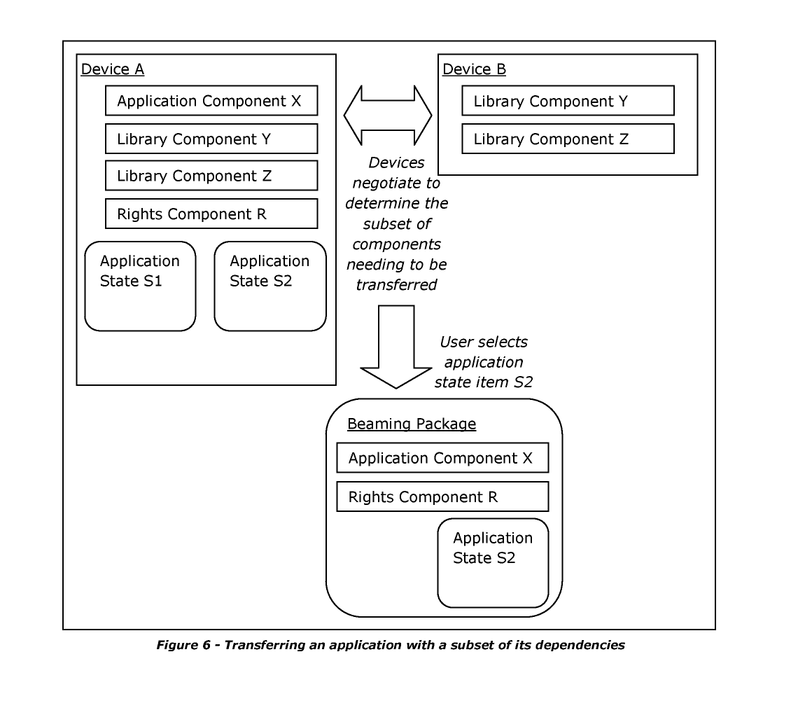

FIG. 6—Transferring an application with a subset of its dependencies.

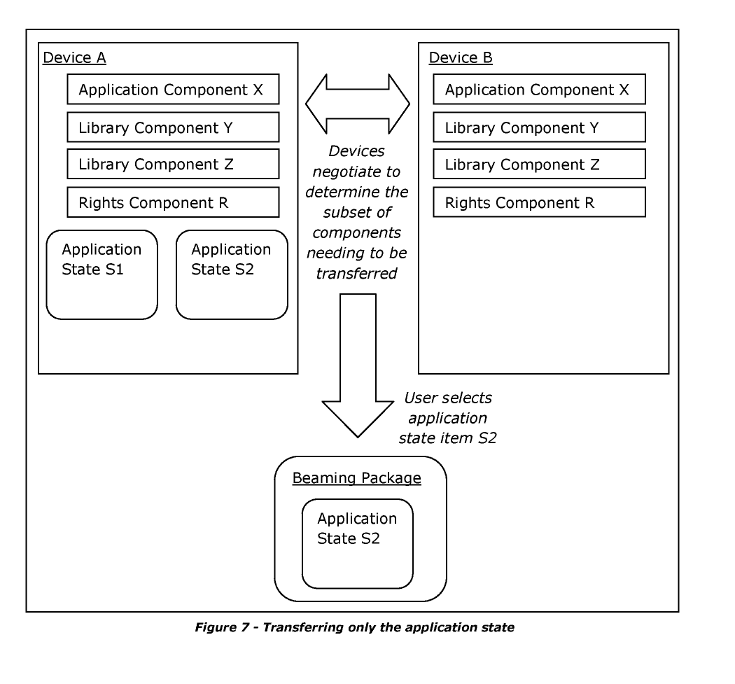

FIG. 7—Transferring only the application state

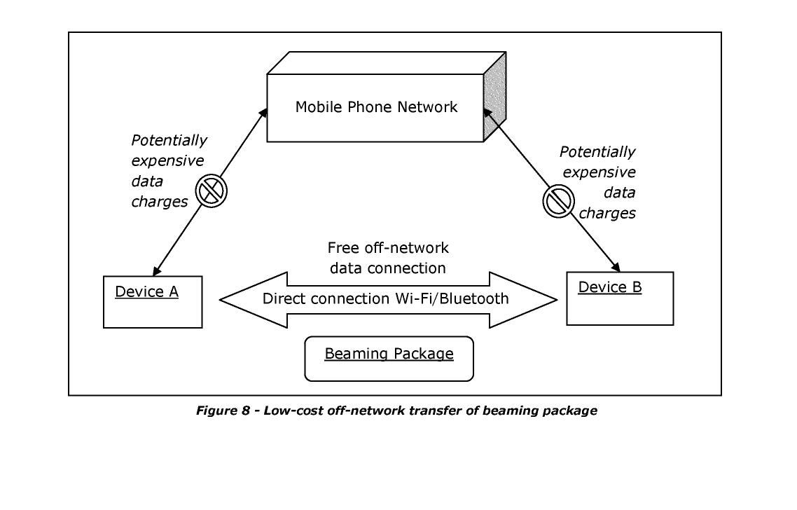

FIG. 8—Low-cost off-network transfer of beaming package.

### 3. DESCRIPTION

3.1 Background

Software applications are typically downloaded from a server or installed from physical media. If downloaded, they often come in installation packages which are discarded after the application is installed.

In many cases, the application has dependencies (other pieces of software) which are required in order for it to work. These are typically either installed manually by the end-user, or included unconditionally in the application's installation package.

Simply installing an application and its libraries is not sufficient to transfer the state of an application from one device to another. Applications generally save data to persistent storage to allow information to persist across different invocations of the application.

This data is described as “application state” in the present patent application, and includes items such as:
Settings
Documents
The current state of an in-progress game
A record of a completed game
User-generated content such as game characters or levels
   along with many others.

Traditional systems do not provide a managed way to take an application installed on one device and transfer it to another, including any necessary dependencies and the application state.

This patent application describes a novel system for doing this for binary-portable software applications across dissimilar device types, whereby parts of the application which are already present on the target device are not transferred, thus reducing the size of the data being transferred and thus the time taken and the costs.

3.2 Benefits

This approach provides some important advantages for the user:
It is very easy for users to transfer applications and their state between dissimilar types of devices where traditionally this is difficult
Because the transfer is (or at least may be) directly from one end-user device to another, this can be done across a cost-free network such as Bluetooth if the users are in close proximity, thus the bandwidth costs of performing such a transfer over a mobile phone network are greatly reduced or eliminated entirely
Transferring applications is possible even where there is no mobile-device network coverage, over short-range zero-infrastructure networks such as Bluetooth or ad-hoc Wi-Fi
The time taken to transfer the application is reduced by analysing the dependencies and transferring only those parts of the application and its dependencies which are required on the target device and are not already present.
Short-range local transfers are typically faster than the mobile phone network in many cases, particularly in developing countries. This also reduces the time taken to transfer applications.

The method preferably includes managed “version control” which automatically notifies the application when new state data is received and which tracks whether it is older, newer or the same as any corresponding state data item already on the device.

The application may be packaged along with the application state data (along with any required libraries) in such a way that the resulting package can be sent as a unit to another device which can then allow the user to view/modify the application state even if the corresponding application was not previously installed on that receiving device.

This allows use-cases which are not commonly available, such as sending a game challenge (as described above) along with the corresponding game, so that the recipient can attempt to beat the sender's score even if they do not already have the game installed. This could be used as a form of try-before-you-buy to encourage the recipient to purchase the game.

There are also benefits to mobile phone network operators. Mobile phone networks struggle with the increasing bandwidth requirements of smart devices, even in developed counties where network coverage is good.

In developing countries the network coverage and the bandwidth availability over mobile phone networks can make it difficult to transfer even modest sized applications in a reasonable time. Transferring large applications such as advanced 3D games takes so long as to make it prohibitive.

The system described here allows network operators to offer an enhanced user experience without requiring costly improvements to the network infrastructure.

Other fields of use include distributed computer systems, TVs, hand-held and fixed gaming consoles and the like.

3.3 Prerequisites

This preferred embodiment is an extension of the system described in the present applicant's published PCT application WO/2010/145886, and uses the same binary-portable software distribution format, packaging format, dependency mechanism and so on as described in that document. The reader is assumed to be familiar with this publication. In the text, it will be referred to as “the prior publication”. The prior publication is incorporated by reference.

3.3.1 Recap of Relevant Parts of WO/2010/145886
The binary-portable software-distribution format takes the form of an intermediate compiler representation of the application program, where the final step of the compilation (code generation, register allocation, etc) is done on the target device when the exact CPU architecture is known.
The packaging format is an extension of the “JAR” file format, called the “ATX” file format. The extensions to the JAR format are simply the definition of some custom manifest properties.
ATX files can have two modes: files containing application code, assets or meta-data (known as ATX components), and files containing other ATX files (known as container ATX files).
ATX components are digitally signed using the standard cryptographic algorithms used by the Java “jarsigner” tool. This is used to ensure authenticity of the content of the ATX file.
Container ATX files are not signed, but the ATX files contained within them typically are, so the authenticity of the content can be verified anyway.
ATX components have within their manifests properties which define various important pieces of information about the component, such as a unique component name (and an associated version number), declarations of the interfaces implemented by the component (with associated version numbers), and dependencies on other components or interfaces, each specifying the valid range of version numbers for that component name or interface.
Each device has a unique device identifier. This is used in the prior publication to lock rights components to specific devices by encoding the relevant device unique IDs into a rights ruleset.

3.4 Creation of a Beaming/Transfer Package

In order to transfer (or “beam”) an application from one end-user device to another, a number of pieces of data must be transferred to the target device. In the invention detailed in this document, this is done by selecting the relevant pieces of data and packaging them into a single container ATX file, called a “beaming package”.

The data to be included in this package includes:
The ATX file representing the application program to be beamed, if it is not already present on the target device.
Any software libraries which are not already present on the target device.
A “rights component” containing meta-data indicating where the application may be purchased from, if appropriate (rights components are described in detail in the prior publication).
Any application state selected by the user to be beamed to the target device. For example, the user may have a number of in-progress saved games, but only wish to beam one of them. Alternatively, the user might wish to beam only their application settings, but not any other saved application state.

The data within the beaming package therefore varies depending on data exchanged with the target device and upon user input.

Sometimes it may not be possible to directly communicate with the target device. This may occur, for example, because the devices' network connections go through a NAT firewall so cannot receive incoming connections easily, and the devices are not close enough together to use a short range technology such as Bluetooth, ad-hoc Wi-Fi or a USB cable. In such a case it cannot be determined which pieces of software required for running the application are already installed on the target device, and so as a fallback the system must include all application software and libraries required by the application, or ask the user which parts they wish to send. Note that even in this case where there is no direct connection between the devices, the transfer of the application may still be possible through an indirect communication mechanism such as e-mail.

However, if the two devices can communicate directly, a better approach is possible: they can communicate and discover which parts of the application and library software need to be transferred.

3.4.1 Negotiation with the Target Device

Given that the source and target devices can communicate, it is possible for them to exchange information about what application, library, asset and meta-data components are installed.

The source device starts with a set of components which it knows need to be present on the target device. This will typically include the main application component itself, plus a rights component if one is available.

Given this list of components, the source device can query whether each component is installed on the target device (using the unique component name and version number as a pair of identifiers). If a component is already installed on the target device, it is removed from the list and is given no further consideration.

Alternatively, a component may be retained in the list, and ultimately sent to the receiving device if the receiving device reports that the version of the component it already has installed is older than the version to be sent (there is version information within the component manifest file).

For each component which is not already installed on the target device, the dependencies of that component are added to the list of components to be considered, and the procedure continues. In this way, the entire set of dependencies of the original set of components are enumerated and checked.

It should be noted that the dependencies as described in the prior publication can fulfilled by either a component with a matching component name or by a component which implements a matching interface name. This means that the implementation of the dependency on the target device may be different from the implementation on the source device. This could be because there is an installable component from a different supplier on the target device which implements the required interface, or it could be because the software environment on the target device contains a built-in implementation of the interface.

Device drivers for hardware such as OpenGL-ES are a common example of this—each hardware manufacturer typically provides their own implementation of the OpenGL-ES software using making use of underlying hardware capabilities. In the absence of this, it is possible that a software implementation of the interface might be present (there may be a number of different software implementations in existence from different vendors).

For the application being beamed this is irrelevant. The interface specifies the behaviour that must be implemented, and so as long as the interface that the application requires is present on the target device, the requirement is satisfied regardless of the implementation.

By following the procedure describe here, the source and target devices can negotiate a set of components which need to be transferred in order for the application to work on the target device.

It is also possible that there might be a dependency which cannot be satisfied on the target device, such as when the application requires an interface which can only be satisfied on devices which have a particular piece of hardware (for example an input device such as an accelerometer). This can be detected at this negotiation stage and the beaming procedure can be aborted with an appropriate message to the user indicating the cause of the failure.

3.4.2 Application State Data

Applications may save a number of separate items of application state data and the user may wish to select a subset of that data to be transferred to the receiving device; often this subset will be a single item of application state data such as an in-progress saved game.

In the system described here, the application itself is not required to interact with the user in order to allow them to select which items of application state data they wish to include in the beaming package. Instead, the application provides the software environment with some meta-data describing the data, which is later used by the software environment to allow the user to select the application state data.

3.4.2.1 Application State Meta-Data

Items of meta-data specified by the application:
User-visible name: Offering the user a choice of different items of application state data to transfer necessitates a user-friendly name for each item. The filename of the data file is not suitable for this, since many operating systems impose restrictions on the characters which are available in filenames, including restrictions on length, ASCII-only characters, lack of case-sensitivity, lack of support for whitespace in filenames, etc.As a result, it is necessary to store the name by which the data should be identified to the user separately from the filename.
Icon: A graphic representing the saved data. For example, a screenshot from an in-progress saved game, or a rendering of a character or level represented by the application state data.
Type: A value specifying what sort of data is represented by the application state item. This allows the available items of application state to be sorted into categories, providing additional information for the user to choose between a number of application state items.

The application provides these meta-data by calling an API function to “register” the application state data as an item which should be available for beaming. The filename of the application state data to be associated with these meta-data is also supplied. The application can update these meta-data later (for example, if the name contains a time-stamp this may need to be updated whenever the data is updated).

The application can call a corresponding function to “deregister” the application state item, marking it as no longer available for beaming (and discarding any stored meta-data).

In addition to meta-data explicitly provided by the application, the software environment automatically records some additional meta-data:
Item ID: A randomly-generated identifier, assigned when the application state item is first registered. Applications are likely to assign names to application state items which follow some pattern, such as the name of a game level, a time-stamp, etc. This makes it quite likely that if an application is used on a number of devices, there could be naming clashes where the same name is used to represent items of application state which are actually not the same.
Recording a random identifier in the item's meta-data makes it possible to determine with a reasonable degree of certainty whether two application state items actually represent the same underlying piece of data or whether they simply happen to have the same name.
The randomly generated identifier uniquely identifies a particular item of application state (i.e. to distinguish it from other items of application state) in a way which persists across modifications to the state data itself and also across transfers between devices. It is the mechanism by which the system recognises that two items of application state are “the same”, which is a prerequisite to comparing them to find which is newer or whether a merge is required.
Version Information: Once application state data starts to be transferred between devices, there exist multiple copies of the data, each of which could be independently updated. This introduces additional problems to do with identifying which version of the data is newer, when conflicts occur, etc.
This is done by recording version-tracking meta-data. This is described in the next section.
Application Name: The name of the application which registers the application state item.
Application Dependency Information: The “AGC-State-AppDependency” property from the application component's manifest. This is encoded into the manifest of the application state ATX file (see below) as a dependency. The application should implement the corresponding interface. This allows the application author to have control over compatibility of changes to the data format of application state files. See “Application State Data Format Changes” for details.
This information identifies the application which corresponds to an item of state. It is typically assigned by the author of the application.

3.4.2.2 Application State Version Tracking

Consider the case where an item of application state data is saved on device A and transferred to device B. There are now two copies of the application state data, either of which might be modified. If subsequently the same item is transferred between these devices again, there are a number of different cases:
Data has not been modified on either device before being transferred.
Data is modified on device A and then transferred to device B again. In this case, the incoming version from device A is newer than the existing version on device B.
Data is modified on device B, but then the data is transferred from device A to device B again. In this case, the incoming version from device A is older than the existing version on device B.
Data is modified on both devices and then transferred in either direction. In this case there is a conflict—neither version is strictly newer than the other, although a naive examination of the file timestamps would imply that there was a strict ordering.

These four scenarios are illustrated in FIGS. 1-4.

It is generally difficult for users to keep track of which versions of saved files are newer than others, and so it is helpful for the system to assist the user by keeping track of changes to the application state data files, detecting these situations and notifying the user.

Clearly this situation is even more difficult for users to keep track of when more than two devices are involved, but the basic cases described above can still be detected and reported to the user.

In the system described by this document, this situation is addressed by storing an ordered sequence of version-record meta-data units where each unit represents a branching or joining point in the lifecycle of the application state item.

A version-record consists of a sequence number (starting at 0 and increasing in units of 1), a hash of the contents of the application state item, and the unique identifier of the device on which the version-record was added (this is the same unique identifier mentioned in the prior publication).

An initial version-record is added when the application state item is initially created. Subsequent version-records are added according to the following procedure:
1. Hash the contents of the application state item (using a method such as SHA-1)
2. Compare the hash against the hash in the previous version-record (the one with the highest sequence number)
3. If the hashes differ, add a new version-record with the next sequence number, the current hash and the current device unique identifier.
4. If the hashes are the same, no new version-record is added.

This procedure for adding version-records is executed at the following points:
Branching: Immediately before an application state item is about to be beamed (or at some user selected time, even in the absence of beaming).
Joining: When receiving an application state item, if there is an application state item existing on the device with the same random ID as the incoming item, this procedure is executed on the existing item.

By following these steps, we build up a history of modifications on different devices. The various scenarios described above can now be distinguished by analysing these version-records:
Data has not been modified on either device before being transferred: The version-records are identical.
Data is modified on device A and then transferred to device B again. In this case, the incoming version from device A is newer than the existing version on device B. The version-records are the same up to the point where the version records finish in the version on device B. The incoming version from device A has some additional records after this point.
Data is modified on device B, but then the data is transferred from device A to device B again. In this case, the incoming version from device A is older than the existing version on device B. The version-records are the same up to the point where the version records finish in the incoming version from device A. The existing version on device B has some additional records after this point.
Data is modified on both devices and then transferred in either direction. In this case there is a conflict—neither version is strictly newer than the other, although a naive examination of the file timestamps would imply that there was a strict ordering. The version-records are the same up to some point, and they both versions have additional records after this point.

3.4.2.3 Application State Data Packaging

In the prior publication, there are two modes described for ATX files—signed “ATX components” which contain code, data or meta-data, and unsigned “container ATX files” which simply contain other ATX files, which themselves are typically ATX components.

This document describes a new type of ATX file—an unsigned file containing an item of application state, plus a manifest containing the meta-data associated with that item (the random identifier, type, version information, etc). The meta-data described above is encoded in the standard JAR manifest format as key/value pairs using the following property names for the meta-data items described above:
AGC-State-AppName: Name of application which registered the application state item
AGC-State-AppDependency: The AGC-State-AppDependency header from the game's manifest
AGC-State-ItemName: The user-visible name of the application state item
AGC-State-ItemID: The random ID of the application state item
AGC-State-ItemType: The type of the application state item
AGC-State-ItemUpdate-n: The sequence of version records for the application state item

Since this file is not cryptographically signed, its contents cannot be relied upon not to be modified. A simple (but non-secure) way to make it slightly more complex for an attacker to modify this data would be to append a cyclic-redundancy-check or similar code to the application state data file, and then encode the resulting data file using a stream cipher using a key based on some hash of the manifest. It should be stressed however that this will not stop a serious attacker and is only useful against casual attempts to modify the data.

Using this approach, modifications to the manifest or the data file will typically result in the CRC data being invalid when the data is decoded, allowing the modification to be detected in the vast majority of cases.

3.5 Beaming the Package

Using negotiation with the target device, the set of application, dependency and rights components required to run the application but not present on the target can be determined. The user then selects zero or more items of application state to be beamed. In an alternative embodiment, the application state(s) to be beamed may be selected automatically with no user-intervention required. For example, it may be convenient in some applications automatically to beam the most recent application state,

As part of the negotiation process, in one embodiment the receiving device can report to the beaming device the application states that it can accept, or that the user of the receiving device wishes to accept (e.g. by way of a user option). This avoids the beaming device transmitting data which will not or cannot be used at the receiving device.

The ATX files for these application state items are generated and stored in a container ATX file, along with the ATX installation packages for all of the application, dependency and rights components that need to be transferred.

The resulting container ATX file is transferred to the target device over any available transport mechanism. This can include OBEX over Bluetooth, as an attachment to an email message, a custom protocol over a Wi-Fi network or a mobile phone network, etc.

3.6 Receiving and Installing the Beaming Package

When a container ATX file is received by the target device, its inner ATX files are examined and a number of actions taken as a result:
1. Rights components are installed, subject to confirmation by the user
2. Application and dependency components are installed, subject to confirmation by the user
3. Any application state items present in the container ATX are processed

The installation of the binary-portable software components in step 2, and the handling of rights components in step 1 are described in the prior publication.

Application state items are processed as follows:
If the application state data file is encoded as described in “Application State Data Packaging” above, the data is encoded by hashing the manifest to produce the decryption key, decrypting the data file and then checking and removing the CRC. If the CRC does not match the transmitted value, the application state item is considered to be corrupt and is discarded.
The AGC-State-AppDependency property from the application state item's manifest is evaluated using the dependency mechanism specified in the prior publication in order to find an application which is capable of handling the application state item being processed. If none is found, the application state item is discarded.
Using the AGC-State-ItemID property from the application state item's manifest, the system determines whether there is an item of application state with the same random identifier existing on the device. If so, it compares the version record information in the two items, and presents the user with a choice of possible actions to take:
   Incoming application state does not correspond to existing application state: The user is asked whether they want to install the application state item, with a default answer of “Yes”.
   Incoming application state corresponds to existing application state, but is newer: The user is asked whether they want to overwrite their existing application state with the incoming application state, with a note saying that the incoming application state appears to be newer. The default answer is “Yes”.
   Incoming application state corresponds to existing application state, but is older: User is asked whether they want to overwrite their existing application state with the incoming application state, with a note saying that the incoming application state appears to be older. The default answer is “No”.
   Incoming application state corresponds to existing application state, but there is a conflict: The user is given the choice of overwriting their existing application state with the incoming application state with a default answer of “No”. If the application's manifest indicates that it can merge this type of application state, the user is also offered a “merge” option, which triggers the application's merge functionality.

If the user does not reject an incoming item of application state, the corresponding data file is stored in a directory visible to the application whose sole purpose is to contain incoming application state data files. In addition, the meta-data for the application-state item is inserted into the target system's record of application state items, in essentially the same way as if the item had been registered in the normal manner by an application. If the user chose to merge a conflict, this is recorded along with the meta-data for the item.

3.7 Application Support

A number of small changes may need to be made to applications wishing to make use of the application state beaming facility. These will be evident to the skilled person on the basis of this disclosure.

3.7.1 Registering and Deregistering Application State Items

Applications may need to call an API function to “register” a saved data file as being available for beaming, as described above.

The application may also deregister data files, removing any stored meta-data for the file and marking it as no longer available for beaming.

3.7.2 Application State Data Format Changes

Sometimes applications may need to change the format of their saved data files. This can happen when features are added or removed, or simply for efficiency improvements, etc.

When this happens, old versions of the application are typically unable to use data files created by the new version, whereas new versions of the application may or may not be able to use data files saved by old versions of the application.

The author of the software application can express information in the application manifest about which versions of the application's data formats are supported using the AGC-State-AppDependency and AGC-InterfaceComponent-n properties.

The AGC-State-AppDependency property is encoded into the meta-data of any application state item created by the application, and into the manifest of any application state items that are beamed to other devices.

This expresses a dependency on a specific interface name and version-range. The application implements this interface. By changing the interface version numbers in these two manifest properties, old application state items can be selectively allowed or disallowed, and new application state data files marked as being incompatible with older versions of the application.

For example:
Application supports one data format, but author expects to provide backward-compatibility with older formats if the data format ever changes

AGC-InterfaceComponent-0:
http://someinterface.mycompanycom/if/game-state/somegame 1.0
AGC-State-AppDependency:
http://someinterface.mycompanycom/if/game-state/somegame 1.0-1.*

In this example, the application states that it supports version 1.0 of the interface. The AGC-State-AppDependency entry which is put into the application state meta-data indicates that it requires at least version 1.0 of this interface, but that it expects future versions of the application which support different data formats to be able to decode it as well.
Application described above has a change to its data format

AGC-InterfaceComponent-0:
http://someinterface.mycompanycom/if/game-state/somegame 1.1
AGC-State-AppDependency:
http://someinterface.mycompanycom/if/game-state/somegame 1.1-1.*

This is an extension of the previous example, in which the data format for application-state has changed. The application now states that it supports version 1.1 of the interface.

Note that this still matches the version range which will exist in application state items created by the earlier version of the application (1.0-1.*). The application is therefore stating that it still supports application state items created by the earlier version of the application which implemented version 1.0 of this interface.

New application state items saved by this application will be assigned the new version range “1.1-1.*”. This will not match the previous version of the application (which implemented version 1.0 of this interface), which is the correct behaviour.
Application changes its data format and drops support for old formats

AGC-InterfaceComponent-0:
http://someinterface.mycompanycom/if/game-state/somegame 2.0
AGC-State-AppDependency:
http://someinterface.mycompanycom/if/game-state/somegame 2.0-2.*

This can be considered as an extension of the previous example in which the application author decides to drop support for all previous application state data format versions, or it could be used in a situation where the author never had any intention of providing backward-compatibility for older data formats. Regardless of the intention, the mechanism is the same.

The application state meta-data from older versions of the application will require a version number in the range “1.*”, so will not match this new version of the application. The application has therefore declared its incompatibility with those versions.

By modifying the major version number, the application authors can keep control over whether they want to retain backward compatibility at each change to the data format.

3.7.3 Actions Taken when Application State Items are Received

When the application starts (or at some other well-defined occasions, such as immediately before displaying a list of saved files for the user to choose from), it is expected to call an API function to enumerate the application state items within the directory described above where incoming application state item data files are stored.

For each item in the enumeration, the application is given the name of the incoming application state data file, the name of the corresponding existing application state data file (if any), information about which is newer and whether there was a conflict, and whether the user chose to install the incoming version or attempt a merge.

The application is required to validate the contents of the incoming application state data file (to check for deliberate modification, corruption, etc). Application state data files are a common attack vector for gaming systems, so it is important the applications robustly check the validity of incoming application state data files to protect against buffer-overruns, etc.

Once the application has validated the incoming file, it should take one of the following actions:
Call an API function to accept the incoming file, giving a filename elsewhere (not within the “incoming” directory) to which the data file should be moved. If there was an existing application state data file with the same AGC-State-ItemID, it will be replaced by the incoming file, including its meta-data. The filename to which the incoming data is to be saved may be the same as the filename of the existing application state data file which is being replaced, or it may be different in which case the existing data file will be removed.
Call an API function to remove the incoming file and its corresponding meta-data. Since by this point the user has already answered “Yes” to the question of whether they want to accept the incoming file, the only situations in which this is likely to be appropriate are if the incoming application state file is invalid or if the application has performed some merging and updated the existing application state data file, so that the incoming file is no longer required.

By following these rules, the incoming directory should only contain files which have recently been received on the device and which require attention from the application, while the application retains control over the naming convention and directory structure of application state files within its data directories.

The application can provide simple merging facilities if it chooses at this point.

For example, a chess game using the application state beaming mechanism to transmit the turns from one player to another might perform a check on incoming state items representing an in-progress saved-game, to ensure that the received game matched its record of the game state (i.e. all previous moves the same) with one extra move having been made by the opposing player. Effectively the incoming application state is merged with the existing state.

More complex merges might be possible if the application state data format contains internally a record of individual changes, enabling the application to detect individual modifications within the file and resolve which items should be retained from each file, perhaps with user confirmation.

### 4. USAGE SCENARIOS

This section describes some use-cases supported by the system described in this document.

Transferring an Application Along with all of its Dependencies and State

In a situation where there is no direct communication from the source device to the target device, the two devices cannot negotiate the set of application and dependency components which need to be transferred in order to make the application work.

In this situation, it is necessary to transfer the entire set of components. The user may optionally select some application state to be transferred along with the application.

There are many reasons why the source and targets might not be able to communicate directly, including connectivity reasons and also the situation where the target device is not known at the time that the beaming package is created—for example if the source device creates the beaming package and makes it available for download on a publicly accessible web server.

The transfer process is illustrated in FIG. 5.

4.2 Transferring an Application with a Subset of its Dependencies

A more useful case is where the source and target devices are able to communicate. In this case, they are able to determine the exact subset of components that need to be transferred.

Again, the user may choose some application state to be included in the beaming package.

This is illustrated in FIG. 6.

4.3 Transferring only the application state

The ultimate example of the negotiation between the source and target devices is where they determine that the target device has all of the components that it needs in order to run the application. In this case, only application state items (if any are selected by the user) need to be transferred.

This is illustrated in FIG. 7.

4.4 Transferring over a short-range network when there is no phone network coverage

A key advantage of this system is the “off-network” transfer of the data—typically over a short-range wireless technology such as Bluetooth or Wi-Fi (including ad-hoc Wi-Fi where no existing Wi-Fi network is required). A wired connection such as USB or Ethernet can also be used where appropriate.

This is illustrated in FIG. 8.

1. A method of distributing binary-portable software comprising:
(a) running a software application on a first user device and storing application state data defining a state of the software application;
(b) receiving from a second user device details of required software components needed to run the software application and not already installed, or details of required software components needing updating;
(c) generating a package for transfer to the second user device including the application state data and the required software components:
(d) transferring the package to the second user device;
(e) determining whether the said state has already been saved at the second user device; and
(f) providing an option to a user of the second user device to run the software application from the said state.

2. A method as claimed in claim 1 in which the required software components include any of the following which are not already installed on the second user device: a binary-portable software component, a rights component, and any necessary software libraries or dependencies.

3. A method as claimed in claim 1 in which the package includes a binary-portable software component, the method providing the user of the second user device with an option to run from the said state a software application not previously installed.

4. A method as claimed in claim 1 including providing an option to a user of the first user device of the desired state to be transferred.

5. A method as claimed in claim 1 including receiving from the second user device details of the state or states already stored on the second user device, and excluding from the package said already stored state or states.

6. A method as claimed in claim 1 in which the package is transferred without modification from the first user device to the second user device.

7. A method as claimed in claim 1 including warning a user of the second user device if the transferred state is older than or conflicts with a state already stored on the second user device.

8. A method as claimed in claim 1 in which the application state data defines a plurality of state records, a new state record being added to the application state data when a hash of the most-recently stored state differs from a hash of the current state which is to be saved.

9. A method as claimed in claim 8 in which, on receipt of the package at the second user device, a hash of the transferred state is compared with a hash of a state stored at the second user device, and if different, the transferred state is stored at the second user device.

10. A method as claimed in claim 1 in which the said state is identified by a randomly-generated identifier and comparing said state with a state or states having the same identifier already stored at the second user device.

11. A method as claimed in claim 1 in which the package includes a data format indicator, the said indicator being read by the second user device to determine whether the transferred data format is compatible with the data format in use on the second user device.

12. A method as claimed in claim 1 in which the second user device merges the transferred state with a state already stored on the second user device, and runs the application software based on the merged state.

13. A method as claimed in claim 1 in which the first and second user devices are mobile phones.

14. A method as claimed in claim 13 in which the software application is a game.

15. A computer-readable media storing program code for implementing on a digital computer the method of claim 1.
